(19) United States
(12) Patent Application Publication
(10) Pub. No.: US 2008/0189198 A1
(43) Pub. Date: Aug. 7, 2008

(54) Means and methods to combine various U.S. real estate price reports to create one continuous index from the present to 1830

(76) Inventor: Kenneth G. Winans, Novato, CA (US)

Correspondence Address: STEVEN A. NIELSEN;ALLMAN & NIELSEN, P.C, 100 Larkspur Landing Circle, Suite 212, LARKSPUR, CA, 94939, US

(21) Appl. No.: 11/670,914

(22) Filed: Feb. 2, 2007

(51) Int. Cl. G06Q 99/00; G06Q 40/00

(52) U.S. Cl. 705/35; 705/1

(57) ABSTRACT

A continuous index of new home prices from the present to 1830 is created by performing a series of calculations upon the real estate price reports of the Census Bureau, Bureau of Labor and Statistics, Long, Gottlieb and Riggleman. A yearly or monthly reverse percentage change in new home prices is found by considering the price data of a future time period and earlier time period. Calculations generated from a more recent or subsequent price report are used to seed calculations for analysis of an older or preceding price report. In order to combine price reports with differing metrics and scales, the disclosed system works backwards in time and uses methods tailored to characteristics of each price report.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A SEQUENCE LISTING

Not Applicable

### BACKGROUND OF THE INVENTION

(1) Field of the Invention

The invention relates to means and methods of measuring trends and/or changes to U.S. new home prices from the present to 1830. Various reports of new home prices with different types of data and reporting frequencies are combined into one continuous index for use in making investment decisions and viewing long-term price cycles.

(2) Description of the Related Art

Several attempts to estimate, track, measure, or normalize relatively current real estate prices are known in the related art. U.S. Pat. No. 6,401,070 to McManus discloses a system of estimating real estate property values based upon purchase and refinance transactions using a repeat sales model. McManus accesses a database to study the reselling or refinancing of individual homes. While McManus does produce a time-varying price index, McManus fails to address the fact that data for individual homes and individual refinance transactions for the nineteenth century and early twentieth century is not readily available.

U.S. Pat. No. 6,606,109 to Bradley combines a plurality of predictive models or home price forecasts to estimate the current value of a real estate entity. While Bradley may successfully select, convert, and combine price estimates, Bradley fails to provide means to either select, convert, or combine historical real estate data.

U.S. Pat. No. 6,058,369 to Rothstein derives a real estate market index for use in analyzing proposed real estate transactions. Rothstein provides means of creating a current study and analysis of real estate values but fails to analyze or address historic real estate studies or historic real estate trends. Rothstein creates an index using data not historically available such as numbers of active listings, expired listings and total listings.

There is relatively little information regarding prices of new homes dating back into the ninetieth century. The related art is focused upon examining current or near current real estate prices, and thus fails to analyze the long-term price cycles of the past 170 years.

The few historical real estate studies available use different metrics to measure new home or new construction prices. Thus, there is a need in the art for means and methods to accurately combine historic real estate studies of differing metrics and reporting frequencies into one useful index suitable for reference in viewing long-term real estate cycles.

### BRIEF SUMMARY OF THE INVENTION

The present invention overcomes shortfalls in the related art by providing an accurate, reliable, and useful method of combining the five major studies of new home prices dating from the present to 1830. These studies are:

1. The Riggleman Studies (1830-1837);

2. The Gottlieb Studies (1837-1868);

3. The Long Studies (1868-1936);

4. The Bureau of Labor & Statistics' New Single Family Housing Studies (1936-1963); and

5. The Census Bureau's monthly studies (1963 to present).

These five major studies lack uniformity in their reporting frequencies and in the types of data reported. From the present to 1830, methodologies in recording new home prices have changed significantly, thus, there is little or no uniformity in the information recorded by the five major studies. Methodologies within certain studies changed at various points in time. For example, in the Census Bureau's monthly studies of 1963 to the present, average new home prices were not reported until 1975. Thus, an estimated average calculation was developed for application to the Census Bureau data of 1974 to 1963.

The five studies report at a monthly or yearly frequency and report average and/or median home prices, total permit values, value for all residential building, or other types of data. In order to provide a meaningful and continuous index of new home prices from the present to 1830, a novel system of using reverse percentage changes, seeding prior studies with reference points or data from subsequent studies, calculating estimated average prices, calculating index values and using other techniques is disclosed.

The invention uses non-seasonally adjusted data to track monthly and/or yearly percentage changes in new home prices and/or related data to create an appropriately adjusted index that allows comparison of historic real estate trends to other investments such as stocks, bonds and mutual funds. In order to provide an “apples to apples” comparison with other investment vehicles, the disclosed method makes no adjustments for inflation. Adjusting values for inflation would require the arbitrary selection of a base year, which may or may not coincide with the base year used by a stock index or other investment index adjusted for inflation.

In order to normalize the different types of data collected by the five major real estate price reports, different techniques are disclosed for each report to calculate the index value and the reverse percentage change for each reporting period. The disclosed method requires the use of data in a future year or future period to derive the index or reverse percentage change of the present year or period. The disclosed method uses data from a subsequent or future residential price study to start analysis of a prior residential price study. By working backwards in time and adjusting calculation techniques to fit each report, an accurate and continuous index is created. The principles of the invention are easily adaptable to future real estate price reports that may measure data differently than the five studies or reports specifically considered by the invention.

These and other objects and advantages will be made apparent when considering the following detailed specification when taken in conjunction with the drawings.

### BRIEF DESCRIPTION OF THE DRAWINGS

FIG. 1 is a table demonstrating calculations and selected values consistent with the principles of the invention as applicable to the Census Bureau's Study of New Home Prices.

FIG. 2 is a table demonstrating calculations and selected values consistent with the principles of the invention as applicable to the Census Bureau's Study of New Home Prices for part of 1975.

FIG. 3 is a table demonstrating calculations and selected values consistent with the principles of the invention as applicable to the Census Bureau's Study of New Home Prices from Dec. 31, 1974 to 1963.

FIG. 4 is a table demonstrating calculations and selected values consistent with the principles of the invention as applicable to the Bureau of Labor & Statistics Studies from 1963 to 1951.

FIG. 5 is a table demonstrating calculations and selected values consistent with the principles of the invention as applicable to the Bureau of Labor & Statistics Studies from 1951 to 1936.

FIG. 6 is a table demonstrating calculations and selected values consistent with the principles of the invention as applicable to the Long Studies from 1936 to 1868.

FIG. 7 is a table demonstrating calculations and selected values consistent with the principles of the invention as applicable to the Gottlieb Studies from 1868 to 1837.

FIG. 8 is a table demonstrating calculations and selected values consistent with the principles of the invention as applicable to the Riggleman Studies from 1837 to 1830.

### DETAILED DESCRIPTION OF THE INVENTION

The invention produces a continuous index value and reverse percentage change measurement on a monthly or yearly basis, depending upon the reporting frequency of the relevant real estate price study. For each study, a unique method is employed to derive the index value and the reverse percentage change measurement. For purposes of viewing long term price cycles, the periodic reverse percentage change measurement may be exceptionally useful in analyzing current and historic real estate investment opportunity and volatility. For example, the relative effect of the Great Depression, Civil War, World War I & II, and other major events may be viewed on a yearly percentage change basis by use of the present invention.

Each specific calculation relative to each real estate study will become apparent when considering the characteristics and applied calculations for each individual study and/or portion of each study. Certain values in the tables may not calculate to the precise value described due to rounding in the median reverse percentage change calculations. The date ranges listed for each of the studies or price reports reflect the dates used in the preferred embodiment of the invention as disclosed herein. Alternative embodiments are contemplated wherein different dates are used to move from one study to the next. The date range listed for each of the studies does not necessary reflect a studies' entire time range.

Census Bureau New Home Prices—Present to Jan. 31, 1975

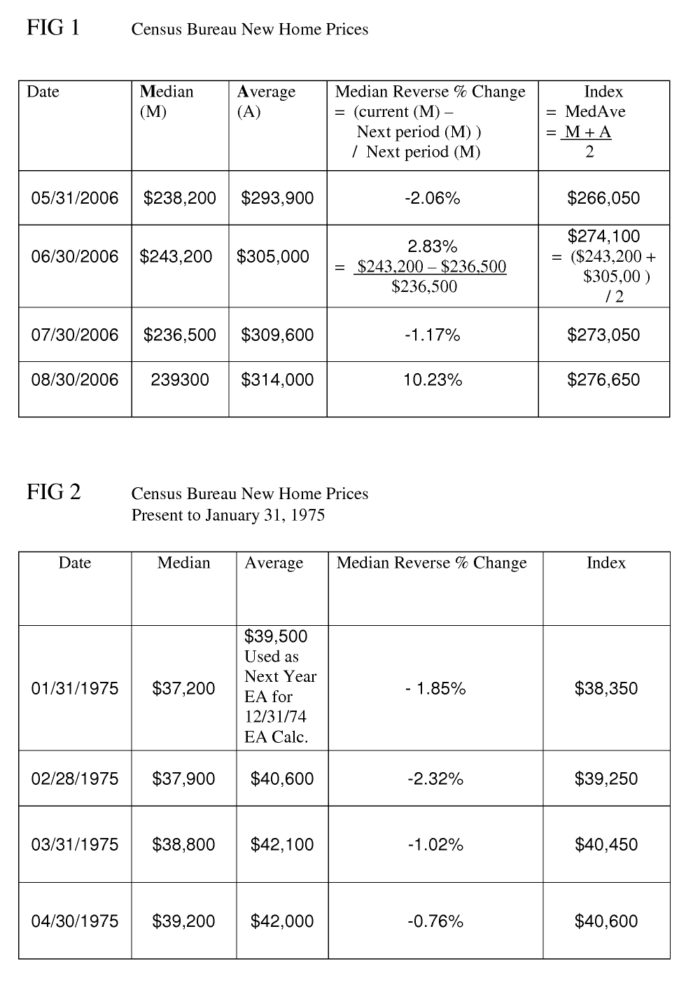

From the present time to Jan. 31, 1975, the US Census Bureau has issued monthly reports of median new home prices and average new home prices. FIG. 1 reflects Census Bureau median new home prices (M) and average new home prices (A). For this time period of the present to Jan. 31, 1975, the index of the invention is calculated by averaging M and A for each reported time period.

For example, in FIG. 1, for Jun. 30, 2006 M is $243,200 and A is $305,000. The index is (M+A)/2 or ($243,200+$305,000)/2 or $274,100. For this time period, the index value may be referred to as the MedAve or medium average.

The median reverse percentage change or MR % C is found by subtracting the median new home price (M) of the next period from the M of the current period; and then dividing the result by the M of the next period. For example, FIG. 1 shows a median reverse percentage change calculation for Jun. 30, 2006 where $243,200 is considered the M for the current period, and Jul. 30, 2006 is considered the next period with an M of $236,500. The MR % C for Jun. 30, 2006 is ($243,200-$236,500)/$236,500=0.0283 or 2.83%.

Census Bureau New Home Prices—Dec. 31, 1974 to Dec. 31, 1963

From Dec. 31, 1974 to Dec. 31 1963, the Census Bureau did not report an average home price. To overcome this dilemma, the invention derives an estimated average (“EA”) price by multiplying the EA of the next period by the current median reverse percentage change (MR % C) and adding the EA of the next period.

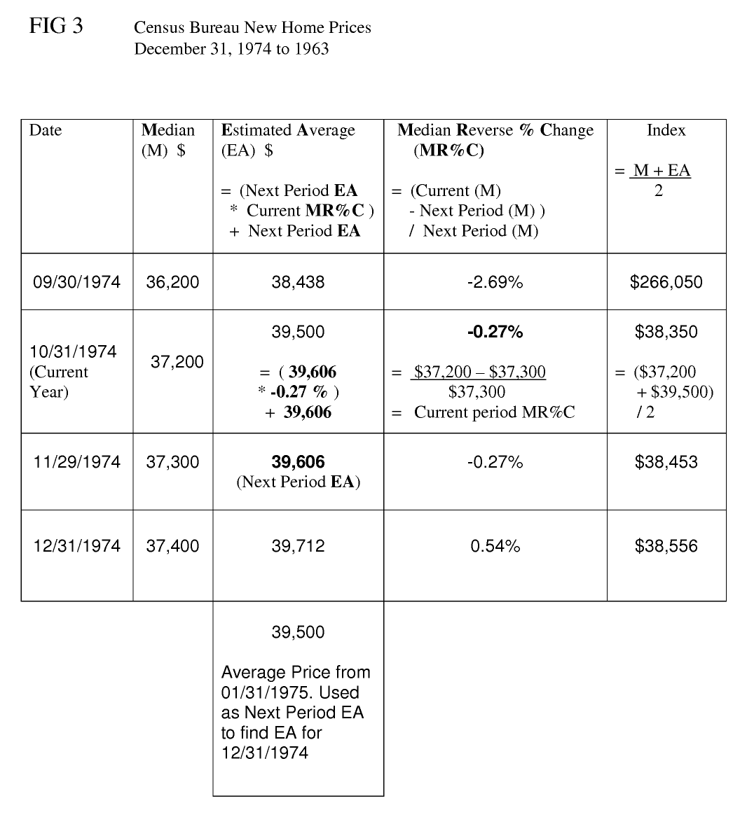

To seed the calculation of EA, the average new home price reported on Jan. 31, 1975 is used as the next period EA in calculating the EA for Dec. 31, 1975. For example, FIG. 2 shows an average new home price of $39,500 for Jan. 31, 1975. This value is used to as the next period EA in FIG. 3 in calculating the EA for Dec. 31, 1974. The EA for Dec. 31, 1974 is $39,712 and equals (Next Period EA*Current MR % C)+Next Period EA or ($39,500*0.54%)+$39,500=$39,712. Note that the reported MR % C has been rounded up on all tables, thus, the apparent EA for Dec. 31, 1974 is $39,713.

The MR % C of Dec. 31, 1974 is the (Current M minus Next Period M) divided by Next Period M and equals 0.005376 or 0.54% which equals ($37,400, Current M of Dec. 31, 1974-$37,200, Next Period M Jan. 31, 1975, FIG. 2)/$37,200 (Next Period M, Jan. 31, 1975).

The index value calculation from Dec. 31, 1974 to 1963 is shown for Oct. 31, 1974 in FIG. 3, where Oct. 31, 1974 is labeled the “Current Year”. The index value is (M+EA)/2 and for Oct. 31, 1974 equals $38,350 which equals (37,200+39,500)/2.

The EA or Estimated Average for Oct. 31, 1974 considers Nov. 29, 1974 as the “Next Period” in following the calculation of EA=(Next Period EA*Current MR % C)+Next Period EA and equals $39,500=($39,606*−0.27%)+$39,606.

Referring to FIG. 3, the MR % C value of Oct. 31, 1974 is the (Current M−Next Period M)/Next Period M where Nov. 29, 1974 is considered the Next Period. The MR % C value of Oct. 31, 1974 is −0.27% or −0.00268 which equals ($37,200−$37,300)/$37,300.

Bureau of Labor and Statistics Studies—1963 to 1951

The Bureau of Labor and Statistics Studies fail to provide an average or median value for new home prices but do provide a yearly New Housing Total Value (“NHTV”) of new private nonfarm housing. In order to generate a Median Reverse Percentage Change value the NHTV is used in place of the median value used in the Census Bureau Studies.

The Bureau of Labor and Statistics Studies fail to directly report an index value or similar data analogous to the index value calculated for the Census Bureau Studies. The reporting of total value of new housing prevents the use of an Estimated Average method as implemented in the Dec. 31, 1974 to 1963 time period of the Census Bureau Studies.

To overcome this shortfall in the Bureau of Labor and Statistics Studies, the invention uses an index value from a future or next time period in combination with the Median Reverse Percentage Change of the current period to derive an index value that is continuous with the Census Bureau index and properly adjusted within each reported time period of the Bureau of Labor and Statistics Studies.

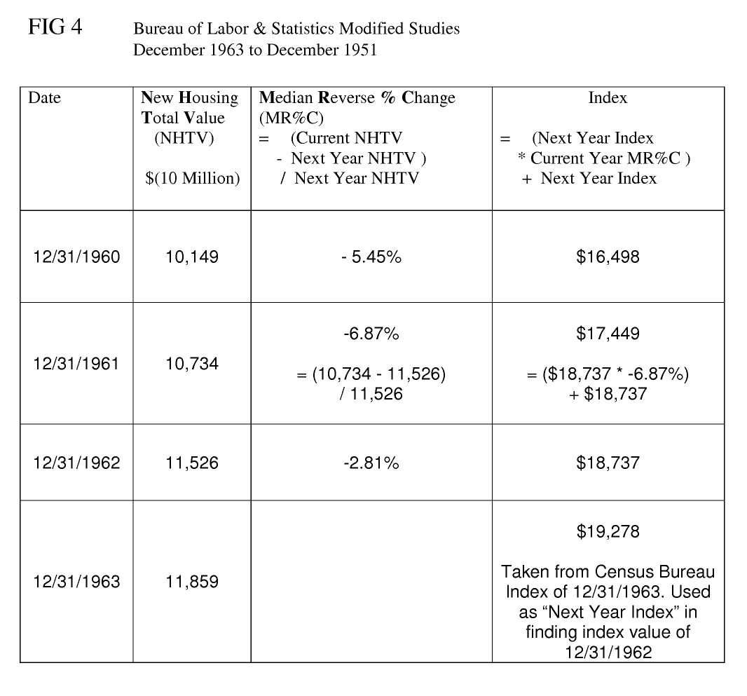

FIG. 4 shows that the calculated index value $19,278 of Dec. 31, 1963, taken from the Census Bureau index calculation is used as the “Next Year Index” in deriving the index value of Dec. 31, 1962, the first reported period in the Bureau of Labor and Statistics Studies. The index calculation for Dec. 31, 1962 to Dec. 31, 1960 is (Next Year Index*Current Year MR % C)+Next Year Index. For example, the index value for Dec. 31, 1962 is ($19,278*−2.81%)+$19,278 which is $18,737.

The Median Reverse Percentage Change (MR % C) is (Current NHTV−Next Year NHTV)/Next Year NHTV. For Dec. 31, 1961 the MR % C is (10,734−11,526)/11,526 which is −0.06871 or −6.87%.

For Dec. 31, 1961 the index value is ($18,737*−6.87% or −0.06871)+$18,737 which is $17,449.

Bureau of Labor & Statistics New Private Nonfarm Housing Units One Family—1951 to 1936

The Bureau of Labor and Statistics data from 1951 to 1936 comprises a yearly report of the total number of new units (U) and the total value (V) of new homes. By using U/V in calculating the Median Reverse Percentage change (MR % C) for each year, greater accuracy is obtained as compared to using V only.

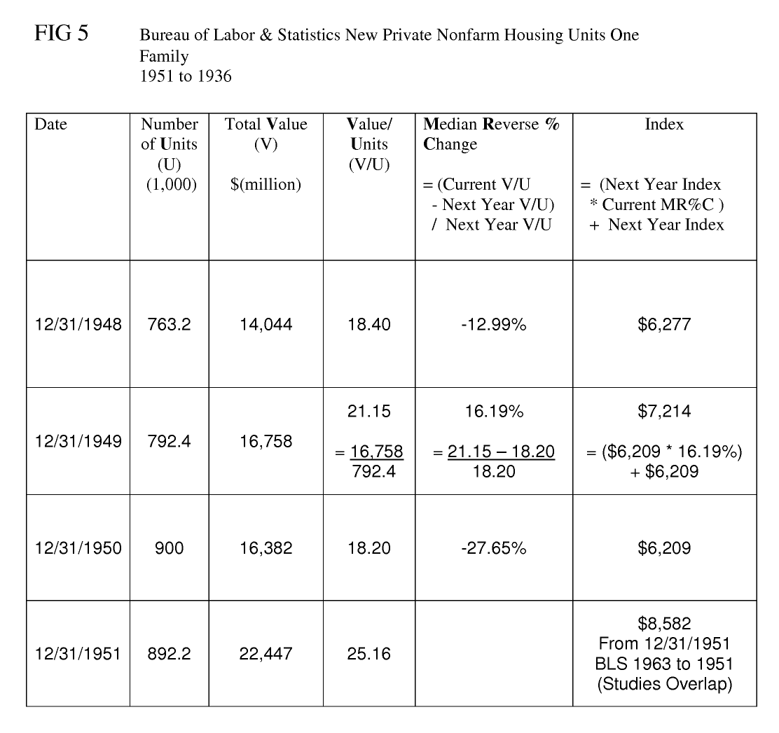

FIG. 5 shows the total number of units “U” in thousands and total value of new home constructed as “V” in millions of dollars. V divided by U is shown as “V/U”. MR % C is found by (Current V/U−Next Year V/U)/Next Year V/U. For Dec. 31, 1949 MR % C is (21.15−18.20)/18.20 which is 16.19%.

The index value is (Next Year Index*Current MR % C)+Next Year Index. For Dec. 31, 1949 the index value is ($6,209*16.19%)+$6,209 which is $7,214.

The Dec. 31, 1951 U, V and V/U values in FIG. 5 are from the Bureau of Labor and Statistics data from 1951 to 1936. The index value of Dec. 31, 1951 of $8,582 is from the Bureau of Labor and Statistics Studies of 1963 to 1951 and is used as the Next Year Index value in finding the index value for Dec. 31, 1950. The two studies overlap in time.

Long Studies—1936 to 1868

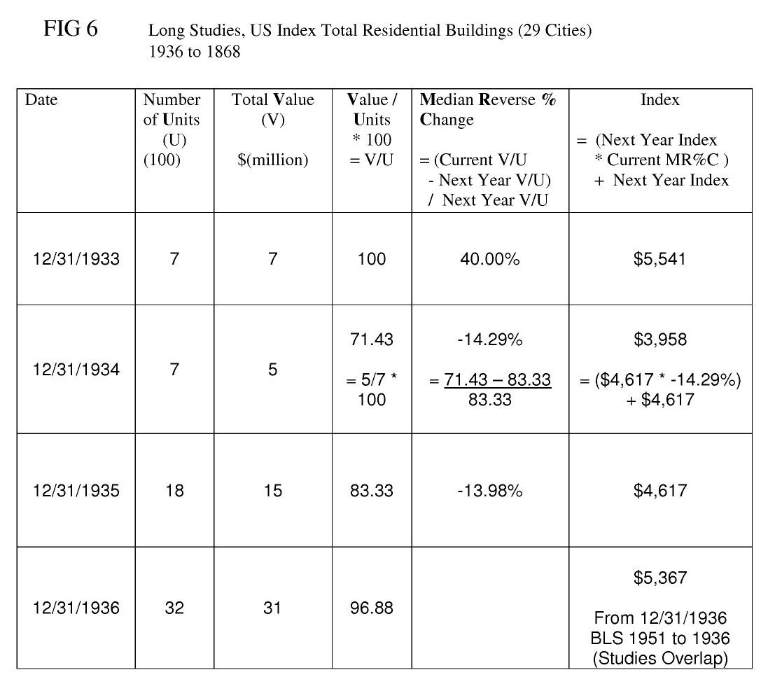

The Long Studies of 1936 to 1868 overlap with the Bureau of Labor and Statistics data from 1951 to 1936 and are similar in format. The Long Studies report the yearly total of new residential buildings and yearly total value of new residential buildings in 29 cities. FIG. 6 shows the total number of new residential buildings in hundreds as “U” and total value “V” in millions. Calculations of MR % C and index value are similar to those of the Bureau of Labor and Statistics of 1951 to 1936 discussed above, except that V/U is multiplied by 100 to achieve proper scaling.

The index value of $5,367 of FIG. 6 is taken from the index value calculated from the Bureau of Labor and Statistics data of Dec. 31, 1936 and is used as the Next Year Index in calculating the index value for Dec. 31, 1935.

Gottlieb Studies 1868 to 1836

The Gottlieb Studies of 1868 to 1836 overlap with the Long Studies, allowing for the use of the Long index value of Dec. 31, 1868 ($1,385) as the Next Year Index for the Gottlieb Index calculation of Dec. 31, 1867.

The Gottlieb Studies are similar to the Bureau of Labor & Statistics Studies of

December 1963 to December 1951 discussed above, in that both studies report a total value only. In the Gottlieb Studies, the yearly data comprises the Total Value (“TV”) in tens of thousands of dollars, of building erected from 1868 to 1836. MR % C and the index value for the Gottlieb Studies and the Bureau of Labor & Statistics Studies of December 1963 to December 1951 are found in a similar fashion.

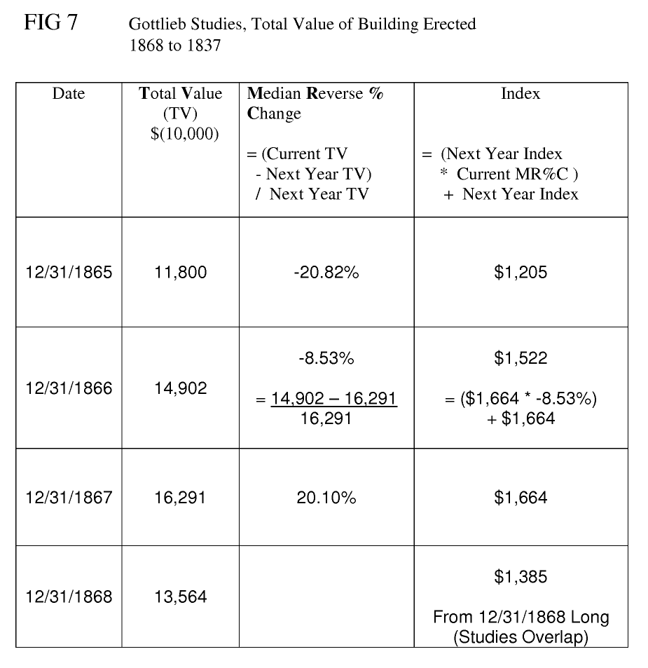

FIG. 7 shows an index value of $1,385 taken from the Dec. 31, 1868 calculation in the Long Studies. The Dec. 31, 1868 TV figure is taken from the Gottlieb Studies. FIG. 7 shows the MR % C for Dec. 31, 1868 as blank. In charting a continuous MR % C graph or grid, the MR % C value of Dec. 31, 1868 from the Long Studies would be used.

Riggleman Studies 1837 to 1830

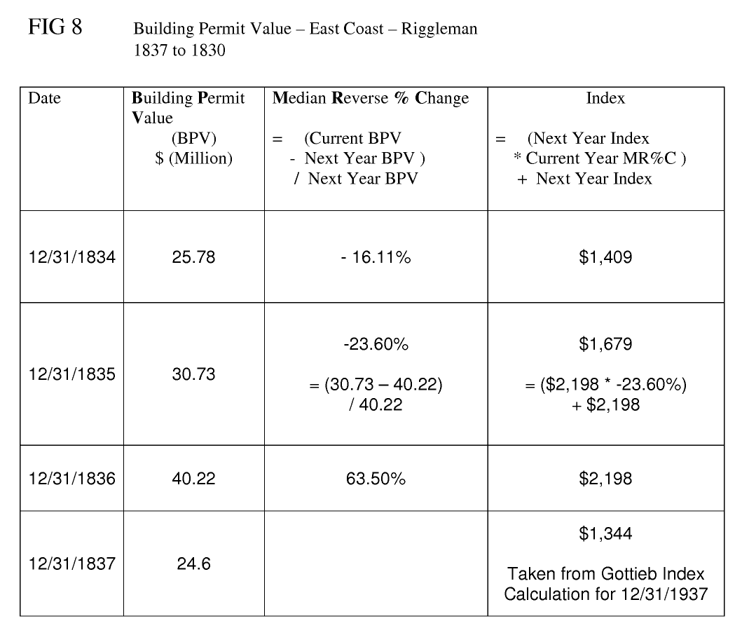

The Riggleman Studies of 1837 to 1830 overlap with the Gottlieb Studies, allowing for the use of the Gottlieb index value of Dec. 31, 1837 ($1,344) as the Next Year Index for the Riggleman Index calculation of Dec. 31, 1836, FIG. 8.

The Riggleman Studies report total Building Permit Value (“BPV”) in millions of dollars. MR % C and index value are found in a fashion similar to that of the Gottlieb Studies. Both studies report a total value only. MR % C is (Current BPV−Next Year BPV)/Next Year BPV. The index value is (Next Year Index*Current Year MR % C)+Next Year Index.

For example, FIG. 8, for Dec. 31, 1835 the MR % C is 30.73−40.22/40.22 which is −0.235952 or −23.60%. The index value of Dec. 31, 1835 is ($2,198* −23.60%)+$2,198 which is $1,679.

What is claimed is:

1. A method of combining price reports of differing scales to create a index comprising the steps of:
a) adding the median home price and average home price and dividing by two;
b) where no average home price is available, calculating an estimated average (EA) home price to replace the average home price value used in step a; and
c) where no average home price is available, calculating an EA by multiplying the Next Period EA (“NPEA”) by the current Median Reverse Percentage Change (MR % C) and adding the NPEA, wherein the MR % C is the current median new home price minus the Next Period Median new home price (“NPM”) divided by the NPM;
d) using an average home price value from step a as a NPEA in step c.

2. The method of claim 1 combining a price report disclosing New Housing Total Value (“NHTV”) and creating an index value by multiplying the Next Year Index Value (“NYIV”) by the current MR % C and adding the NYIV, wherein the MR % C is Current NHTV minus Next Year NHTV divided by Next Year NHTV.

3. The method of claim 2 wherein an index value derived from claim 1 is used as a NYIV in claim 2.

4. The method of claim 3 further combining a price report disclosing Number of Units (U) and Total Value (V) of new housing units and creating an index value by multiplying the Next Year Index by the current MR % C and adding the Next Year Index, wherein the MR % C is the current V/U minus next year V/U divided by next year V/U.

5. The method of claim 4 wherein an index value from claim 2 is used as a Next Year Index.

6. The method of claim 4 further combining a price report wherein the V/U value is multiplied by 100.

7. The method of claim 2 further combining a price report disclosing Total Value (TV) wherein TV is used to replace NHTV.

8. The method of claim 2 further combining a price report disclosing Building Permit Value (“BPV”) wherein BPV is used to replace NHTV.

9. The method of claim 8 used for viewing cycles of changes to real estate prices.

10. The method of claim 8 used for making investment decisions.

11. The method of claim 8 used for comparing real estate investments to other investments.

12. A method of combining price reports from the present to the past comprising the steps of:
a) starting from a more recent price report, creating an index value and reverse percentage change value for the reported periods;
b) using the index value and reverse percentage change value as a next period index value and next period reverse percentage change value in seeding calculations for prior or older price reports.
